(19) United States
(12) Patent Application Publication
(10) Pub. No.: US 2023/0295545 A1
(43) Pub. Date: Sep. 21, 2023

(54) PIPING COMPONENT OF A BREWING SYSTEM

(71) Applicant: Unique Bavarian Brewery, LLC, Castle Pines, CO (US)

(72) Inventors: Michael Anthony Lentz, Bangkok (TH); Wilhelm Trappe, Vienna (AT); Paramase Pholphanich, Nonthaburi (TH); Onnicha Boonsavapark, Pathum Thani (TH)

(21) Appl. No.: 18/186,934

(22) Filed: Mar. 20, 2023

Related U.S. Application Data
(60) Provisional application No. 63/321,479, filed on Mar. 18, 2022.

(51) Int. Cl. C12C 13/00; F16L 41/03; C12C 7/04; C12C 7/14; F04D 15/00; F04D 13/16

(52) U.S. Cl. CPC C12C 13/00; F16L 41/03; C12C 7/04; C12C 7/14; F04D 15/0066; F04D 13/16

(57) ABSTRACT

A fluid coupling system arranged laterally between a first tank and a second tank of a brewing system is provided. The fluid system comprises: a plurality of pipes configured to couple with an inlet and outlet of the first tank and an inlet and the outlet of the second tank; an impeller pump coupling with a pipe; and an actuator coupled with a pipe, configured to facilitate fluid flow through the fluid coupling system. A method of brewing a beverage using a brewing system is also provided, comprising: mashing ingredients within a first tank to form a mash; transferring the mash into a second tank; lautering the mash to form a clarified wort; transferring the clarified wort to the first tank for boiling; transferring the clarified wort to the second tank for chilling; emptying the first tank and the second tank; and cleaning the first tank and the second tank.

### CROSS-REFERENCE TO RELATED APPLICATION

This application claims priority to U.S. Provisional Application No. 63/321,479, titled “Brewing System,” filed on Mar. 18, 2022, the entire disclosure of which is hereby incorporated by reference in its entirety.

### BACKGROUND

Brewing beverages, for example brewing beer, is typically a laborious process that requires several individually conducted steps and large equipment for conducting these steps. The brewing process may be composed of the steps of mashing a milled grain to create a mash, boiling the mash, lautering the mash to form wort and spent grains, clarifying the wort, and fermenting the resulting clarified wort. In typical brewing processes, the equipment required to accomplish these steps may be expensive and occupy a large floor space. The process may additionally require qualified brewing technicians and cleaning staff.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In an example, a fluid coupling system of a brewing system is provided. The fluid coupling system is arranged laterally between a first tank and a second tank of the brewing system. The fluid system comprises: a plurality of pipes coupled with one another and configured to couple with the inlet and outlet of the first tank and the inlet and the outlet of the second tank; at least one impeller pump coupling with at least one pipe of the plurality of pipes; and at least one actuator coupled with at least one pipe of the plurality of pipes configured to aid in facilitating fluid flow through the fluid coupling system; wherein the fluid coupling system is configured to facilitate fluid flow through the first tank and the second tank during a brewing process.

In another example, a method of brewing a beverage using a brewing system is provided. The brewing system includes a fluid coupling system having at least a plurality of pipes, the fluid coupling system arranged laterally between a first tank and a second tank. The method comprises: mashing ingredients within the first tank to form a mash; transferring the mash into the second tank; lautering the mash to form a clarified wort within the second tank; transferring the clarified wort to the first tank for boiling; transferring the clarified wort to the second tank for chilling; emptying the first tank and the second tank; and cleaning the first tank and the second tank.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF FIGURES

Non-limiting and non-exhaustive examples are described with reference to the following Figures.

FIG. 1 illustrates a top perspective view of an exemplary brewing system.

FIG. 2 illustrates a top perspective view of a portion of an exemplary brewing system further depicting various of the internal components of the brewing system.

FIG. 3 illustrates a top view of an exemplary brewing system without covers arranged over first and second tanks.

FIG. 4A illustrates a schematic front view of an exemplary brewing system without an outer housing arranged thereon.

FIG. 4B illustrates a rear schematic view of an exemplary brewing system without an outer housing arranged thereon.

FIG. 5 illustrates exemplary components of a brewing system.

FIG. 6 illustrates an enlarged view of an exemplary piping group of a fluid coupling system.

FIG. 7A illustrates a top perspective view of an exemplary waste-water tank.

FIG. 7B illustrates a bottom perspective view of an exemplary waste-water tank.

FIG. 8A illustrates an exemplary chiller housing.

FIG. 8B illustrates an exemplary chiller.

FIG. 9 illustrates an exemplary chiller configured for working with an air tank.

FIG. 10 illustrates an exemplary reservoir.

FIG. 11 is a flow chart of an exemplary method of operating a piping system during the process of brewing a fluid.

FIG. 12A illustrates an exemplary brewing system with the outer housing shown in a translucent shade to show the internal components of the brewing system with arrows indicating the fluid flow through the piping group.

FIG. 12B illustrates a perspective view of an exemplary brewing system with the outer housing shown in translucency during this step of the brewing process.

FIG. 12C illustrates an exemplary brewing system showing the mash that was transferred into the second tank being removed from the second tank and repeatedly sent back into the second tank.

FIG. 12D illustrates a liquid exiting through the outlet pipe of the second tank and out of an exemplary brewing system.

FIG. 12E illustrates a fluid flowing out of the first and second tanks and into the waste-water tank of an exemplary brewing system.

FIGS. 12F-12H illustrate a liquid transferred from an outside connection into the first tank through pipes of a piping group to mix with the cleaning agents in an exemplary brewing system.

### DETAILED DESCRIPTION

Various aspects of the disclosure are described more fully below with reference to the accompanying drawings, which forms a part hereof, and which show specific example aspects. However, different aspects of the disclosure may be implemented in many different ways should not be construed as limited to the aspects set forth herein. The following detailed description is, therefore, not to be taken in a limiting sense.

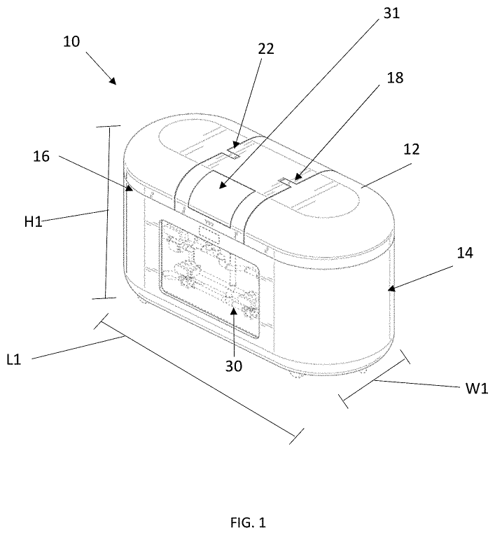

The present embodiment presents a brewing system 10 for use in brewing liquid, for example, for brewing beer. While described throughout as being used for brewing beer, various other liquids may be produced within the brewing system 10. FIG. 1 illustrates a top perspective view of the brewing system 10, which is defined by a generally rounded rectangular shape. More particularly, the brewing system 10 comprises an outer housing 12 that includes a generally rectangular portion and at least two rounded portions arranged on either end of the rectangular portion. As will be described further herein, the rounded portions may be configured for housing a plurality of tanks within the outer housing 12. As illustrated, the brewing system 10 has a length L1 of approximately 230 cm and a height of approximately 155 cm. The height may be defined as a total height of the brewing system 10 from the bottommost surface to a topmost surface. Additionally, the brewing system 10 may have a width of approximately 100 cm. In embodiments, the length L1 may be approximately 7 feet, the width W1 may be approximately 2 feet, and the height H1 may be approximately 5 feet. As a result, the brewing system 10 may cover a ground or floor area of approximately 2.5 m². However, the values provided herein for the above described dimensions of the brewing system 10 are provided as examples and other values may be incorporated. For example, the length L1, the width W1 and the height H1 may all vary depending on the size desires and/or constraints of the brewing system 10.

Further, as will be described further herein, the outer housing 12 may hold a volume of liquid of approximately 30 L to 200 L. In other words, up to 200 L of beer may be brewed at a time within the brewing system 10. However, various other values of liquid may be supported within the brewing system 10 and the above values are provided merely for example. Additionally, the brewing system 10 may be composed of various materials, such as stainless steel and/or titanium. However, various other materials may be incorporated. The weight of the brewing system 10 may be approximately 600 kg to 840 kg. In further embodiments, depending on the materials used, the weight of the brewing system 10 may be less than or greater than the provided example range.

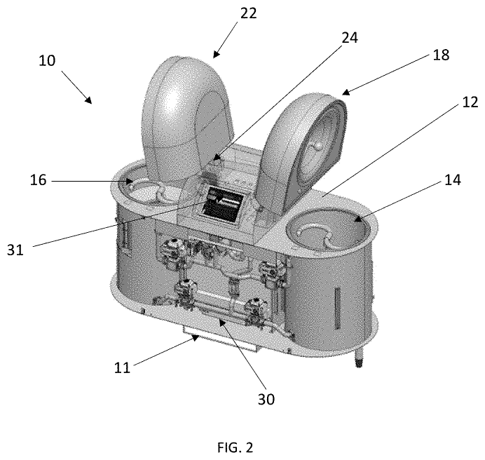

FIG. 2 illustrates a top perspective view of a portion of the brewing system 10, and more particularly, various of the internal components of the brewing system 10. As illustrated, the brewing system 10 includes a first tank 14 positioned distal to a second tank 16 within an interior region of the outer housing 12. The first tank 14 and the second tank 16 may be fluidly coupled through a fluid coupling system 30 positioned between the first tank 14 and the second tank 16. Additionally, the outer housing 12 may include an operator interface 31 arranged between the first tank 14 and the second tank 16. The operator interface 31 may be actuated by a user for selecting a recipe for brewing which may be linked with a software system of the brewing system 10 to cause automatic brewing of the selected recipe.

Further, each of the first tank 14 and the second tank 16 may have a respective cover configured for reversibly covering the first and second tanks 14, 16. More particularly, the first tank 14 has a cover 18 having a hinged connection with the outer housing 12 adjacent to the first tank 14. As illustrated best in FIGS. 1 and 2, the cover 18 is coupled with the outer housing 12 at a hinge assembly 20 such that the cover 18 may be hinged open over first tank 14 from the configuration shown in FIG. 1 to hinged closed over first tank 14 in the configuration shown in FIG. 2. The hinge assembly 20 may be manually actuated and/or automatically actuated through the operator interface 31. With reference still to FIGS. 1 and 2, the second tank 16 also includes a cover 22 having a hinged connection with the outer housing 12 adjacent to the second tank 16. Similar to the cover 18 of the first tank 14, the cover 22 is coupled with the outer housing 12 adjacent the second tank 16 through a hinge connection, namely a hinge assembly 24. In this way, the cover 22 may be manually and/or automatically actuated from the closed configuration of FIG. 1 to the open configuration illustrated in FIG. 2. The covers 18, 22 may be selectively opened when adding ingredients into the first and second tanks 14, 16 and/or when various contents of the first and second tanks 14, 16 are being boiled to allow vapor to be released from the first and second tanks 14, 16. Further, throughout the disclosure herein the first tank 14 may be referred to as the brew tank and the second tank 16 may be referred to as the lauter tank.

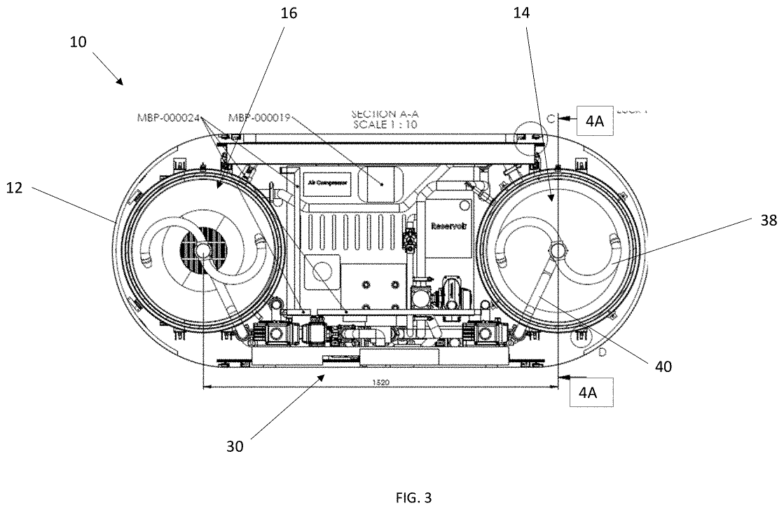

FIG. 3 illustrates a top view of the brewing system 10 without the covers 18, 22 arranged over the first and second tanks 14, 16. As illustrated, the first tank 14 and the second tank 16 are positioned distal to one another within outer housing 12, with the fluid coupling system 30 positioned therebetween.

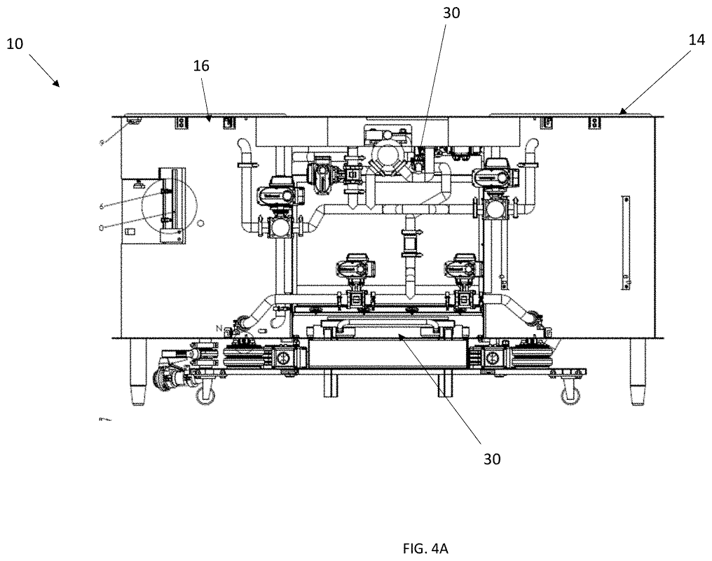

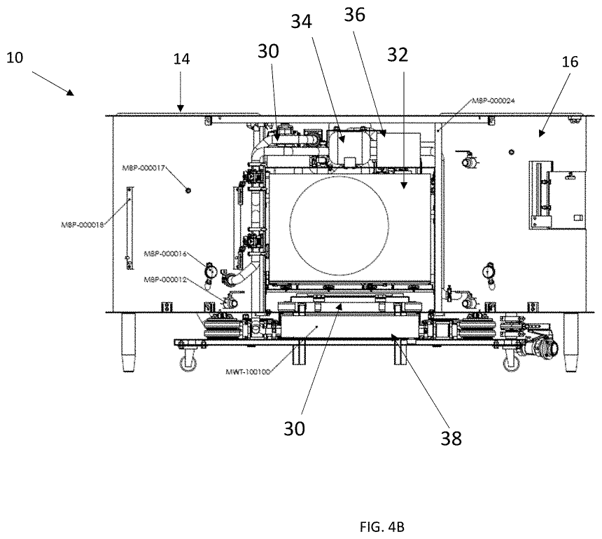

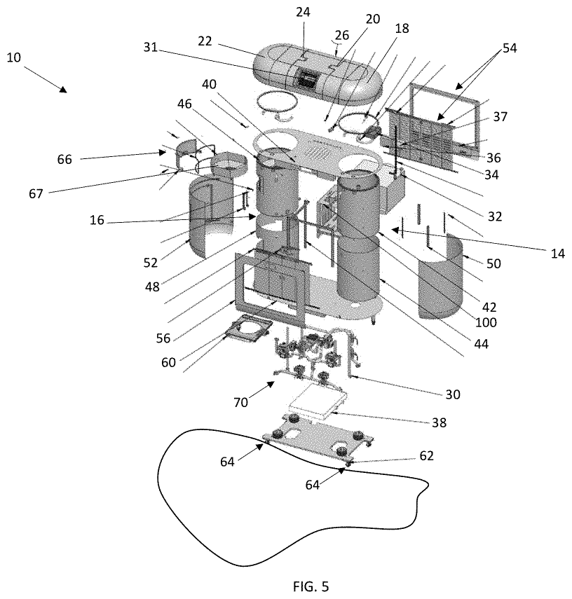

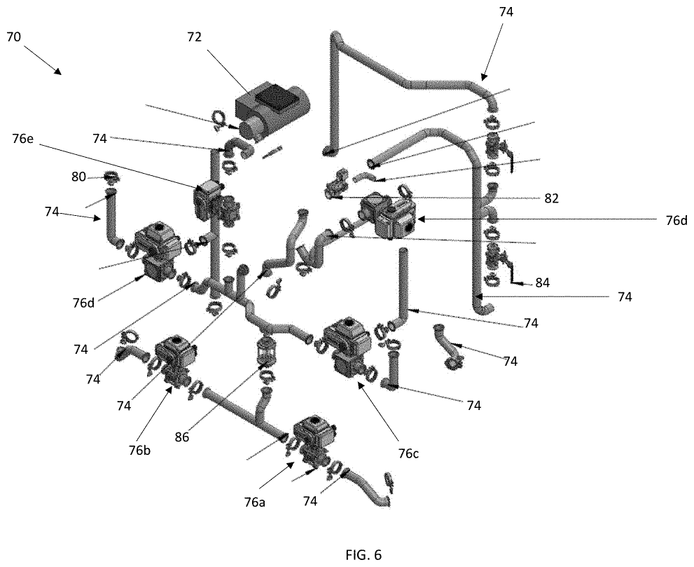

FIG. 4A illustrates a schematic front view of the brewing system 10 without the outer housing 12 arranged thereon. As previously described, the fluid coupling system 30 is arranged laterally between the first tank 14 and the second tank 16 and maintains positioning within the brewing system 10. FIG. 4B illustrates a rear schematic view of the brewing system 10 without the outer housing 12 arranged thereon. As illustrated, the fluid coupling system 30 is arranged laterally between the first tank 14 and the second tank 16 and arranged towards a front of the brewing system 10 such that further components may be incorporated between the first tank 14 and the second tank 16. For example, as illustrated in FIG. 4B, the brewing system 10 additionally includes a chiller 32, a reservoir 34, an air compressor 36, an air tank 37, and a waste-water tank 38. As illustrated, the chiller 32 is arranged at a vertical position generally centrally located within the brewing system 10, the reservoir 34, the air compressor 36, and the air tank 37 are arranged vertically above the chiller 32 and the waste-water tank 38 is arranged vertically below the chiller 32. These components may be fluidly coupled within the fluid coupling system 30 by a piping group 70 of the fluid coupling system 30, as will be described further herein. The piping group 70 of the brewing system 10 will be described further herein with reference to FIGS. 5-6.

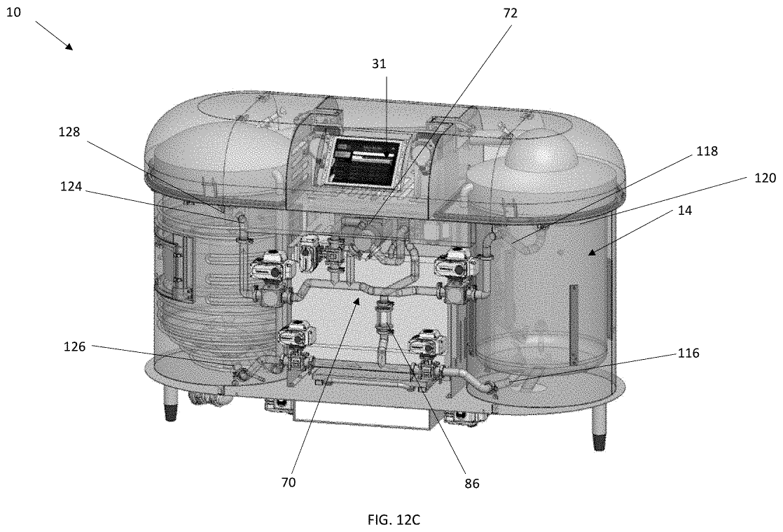

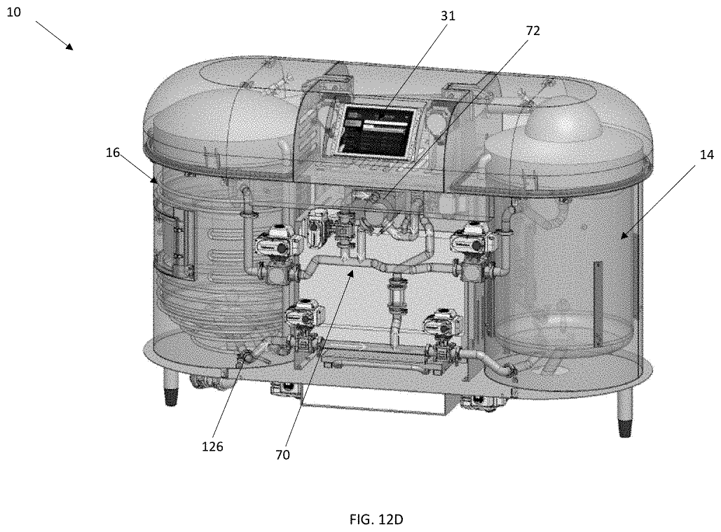

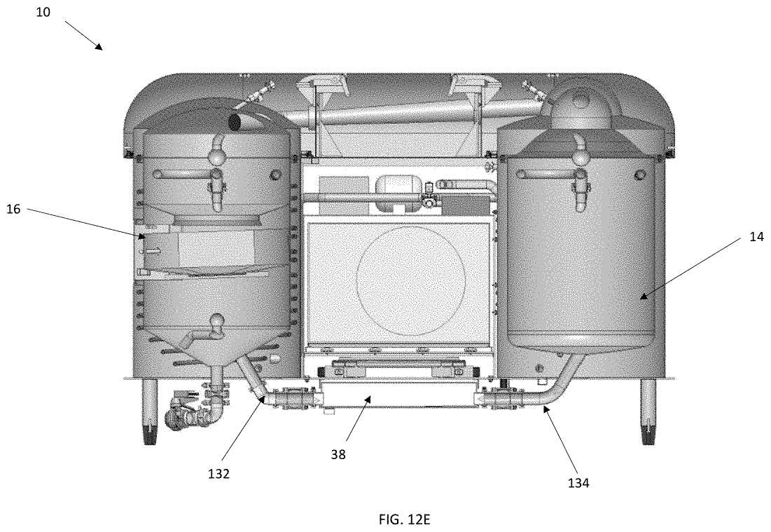

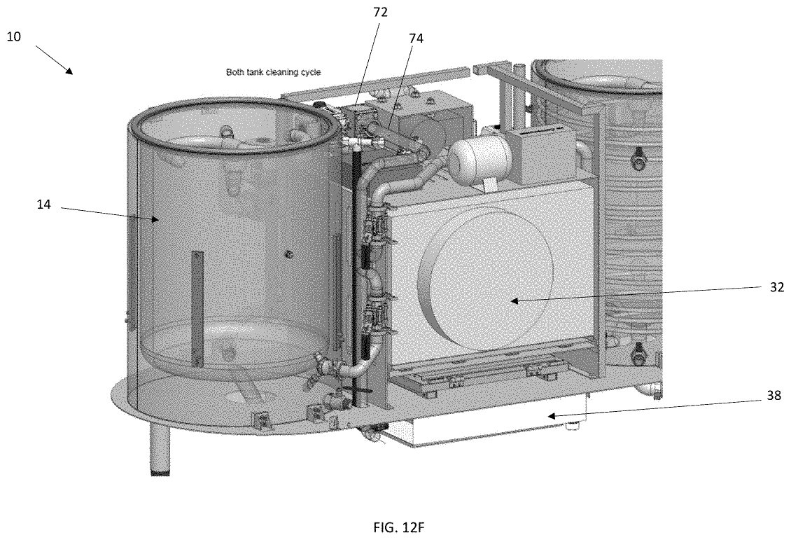

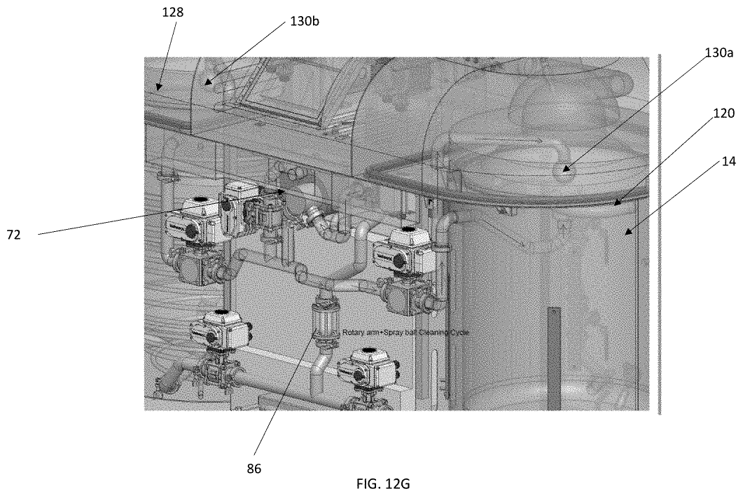

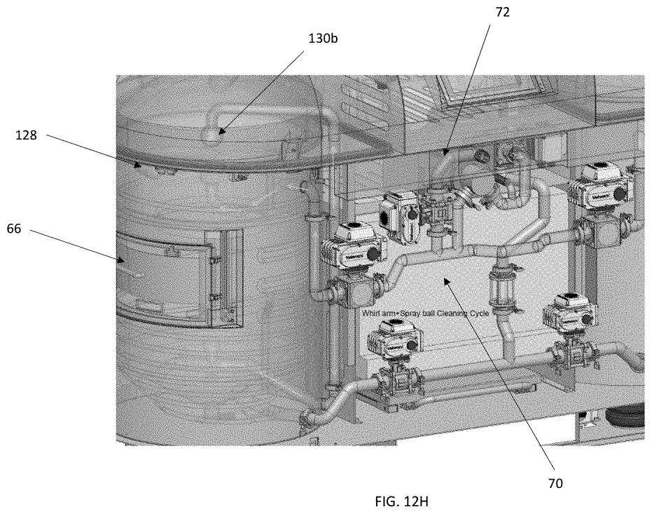

The components of the brewing system 10 will be described further herein with reference to FIG. 5. As illustrated, the brewing system 10 comprising the outer housing 12 defined by an upper portion 26 that include the operator interface 31 and includes the covers 18, 22 which are configured for hingedly opening and closing relative to the first tank 14 and the second tank 16. Further, the brewing system 10 includes a top plate 40 that is arranged over the first and second tanks 14, 16 to aid in coupling the first and second tanks 14, 16 with the upper portion 26. Further, as illustrated, the first tank 14 is defined by an inner cylinder 42 which is received within an outer cylinder 44. Further, the second tank 16 may be defined by an inner cylinder 46 which is at least partially received within an outer cylinder 48. The outer housing 12 additionally includes a first tank plate 50 that is configured for reception around a portion of the first tank 14 which defines an outer side portion of the outer housing 12 and a second tank plate 52 configured for reception around a portion of the second tank 16 which defines an outer side portion of the outer housing 12. Further, with reference still to FIG. 5, the second tank 16 is configured for receiving a grid basket assembly 66 which includes a grid basket 67. During fluid flow of mash through the second tank 16, particles of the mash may be filtered through the grid basket 67 as will be described further with reference to FIGS. 12A-12H. While examples of brewing system 10 are described as including grid basket assembly 66 and various associated aspects, it will be appreciated that, in other examples, such aspects may be omitted.

Further, with reference still to FIG. 5, the outer housing 12 further includes a back plate assembly 54 and a front plate assembly 56 arranged opposite the back plate assembly 54. The back plate assembly 54 and the front plate assembly 56 enclose the space extending between the first tank 14 and the second tank 16 and may also each be removably to provide access into the space extending between the first tank 14 and the second tank 16.

The region arranged between the first tank 14 and the second tank 16 is configured for receiving various components, for example the piping group 70, the reservoir 34, the air compressor 36, the air tank 37, and the chiller 32. The outer housing 12 further includes a bottom plate 60 that is arranged below the first tank 14 and the second tank 16 for aiding in support and enclosing the components within the interior region 58. With reference still to the exploded view of FIG. 5, the brewing system 10 additionally includes a floor plate 62 including a plurality of wheels 64 which may allow for the brewing system 10 to be easily transported.

With reference now to FIGS. 6-10, various of the above described components of the fluid coupling system 30. For example, FIG. 6 illustrates an enlarged view of the piping group 70 of the fluid coupling system 30. As illustrated, the piping group 70 includes an impeller pump 72 configured for coupling with at least one of a plurality of pipes 74. The piping group 70 additionally includes a plurality of actuators 76. As illustrated, the plurality of actuators 76 includes a first actuator 76a, a second actuator 76b, a third actuator 76c, a fourth actuator 76d, and a fifth actuator 76e. However, any number of actuators may be incorporated into the fluid coupling system 30. The arrangement and operation of the actuators 76 may be automatically changed during the operation of the brewing system 10 in order to direct fluid through the plurality of pipes 74 and into the desired areas of the brewing system 10. With continued reference to FIG. 6, the piping group 70 additionally includes at least one tri-clamp 80, at least one solenoid valve 82, and at least one manual ball valve 84. The above described components of the piping group 70 work together to control the fluid movement between the first tank 14, the second tank 16, the waste-water tank 38, the chiller 32, the reservoir 34 and the waste-water tank 38, as will be described further with reference to FIGS. 12A-12H. With reference still to FIG. 6, the piping group 70 additionally includes a sight glass 86 which may provide a visual to the operator of the fluid that is passing through the respective piping pathway. This may be particularly useful during the various steps of the brewing process when the composition and the clarify of the fluid needs to be monitored, as will be described further herein. While examples are described with reference to an exemplary configuration of pipes and actuators, it will be appreciated that other examples may include other piping and/or associated actuators. For example, one or more five-valve or other multi-valve actuators may be used in other examples, thereby simplifying certain aspects of fluid coupling system 30.

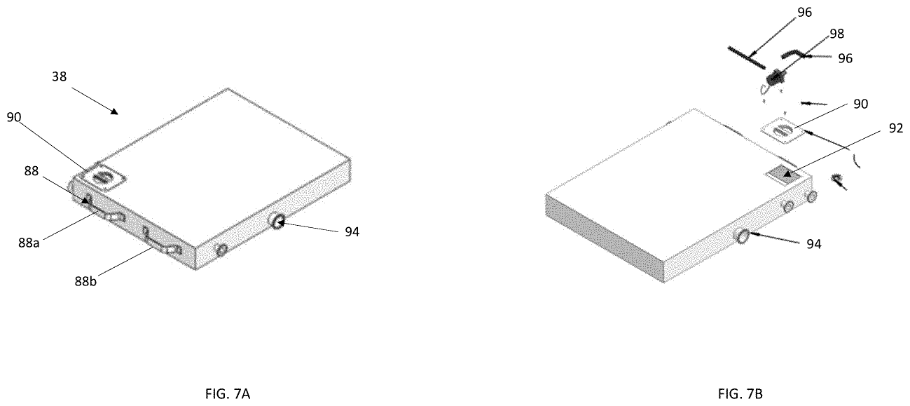

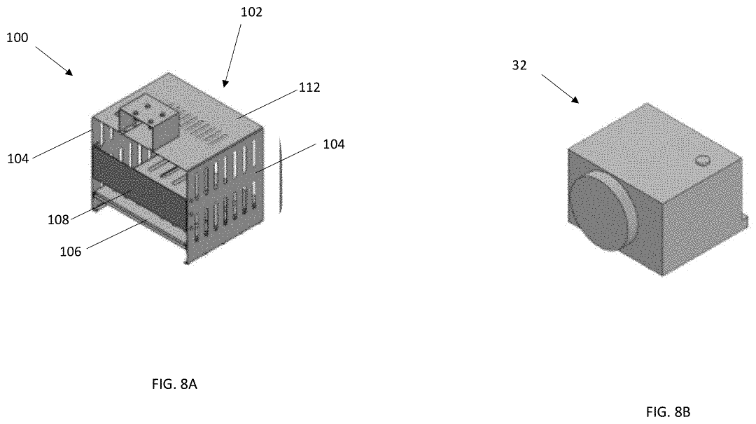

With reference now to FIGS. 7A-7B, the waste-water tank 38 will be described further. For example, FIG. 7A illustrates a top perspective view of the waste-water tank 38. As illustrated, the waste-water tank 38 is generally rectangular in shape and has at least one handle 88, illustratively a first handle 88a and a second handle 88b, which may be used by the operator for arranging or removing the waste-water tank 38 when required to empty the waste-water tank 38. Further, the waste-water tank 38 includes a waste-water tank lid 90 which is configured for reversibly covering an opening 92 of the waste-water tank 38. As illustrated in both FIGS. 7A-7B, the waste-water tank 38 further includes a waste-water tank end cap 94. Additionally, a plurality of hoses 96 and a centrifugal water pump 98 are configured for aiding in the fluid flow in and out of the waste-water tank 38. As will be described further herein, the waste-water tank 38 is configured for receiving waste fluids during the brewing and cleaning processes of brewing system 10. The waste-water tank 38 may be removed by the operator so that the fluids retained within the waste-water tank 38 can be disposed of. It will be appreciated that, in other examples, waste-water tank 38 may be omitted, such that waste-water is alternatively, or additionally, expelled from brewing system 10 using any of a variety of other mechanisms accordingly.

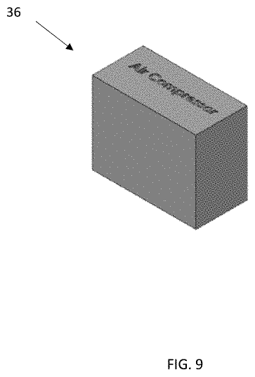

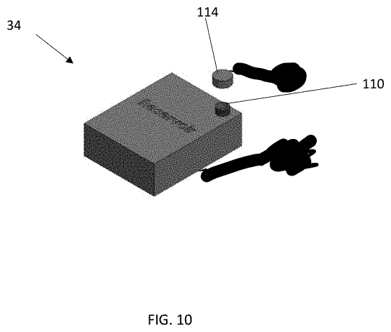

As previously described, the fluid coupling system 30 includes the chiller 32 which may be configured for cooling the fluid that passes through it to allow for the temperature of fluids to decrease during the brewing process. The chiller 32 is housed within a chiller housing 100 as illustrated in FIG. 8A. The chiller housing 100 includes a frame assembly 102 having at least two side walls 104, a bottom plate 106, and a back plate 108 for supporting the chiller 32 therein, as shown in FIG. 8B. In this way, the chiller 32 has a structural support and may be protected while being housed between the first tank 14 and the second tank 16 of the brewing system 10.

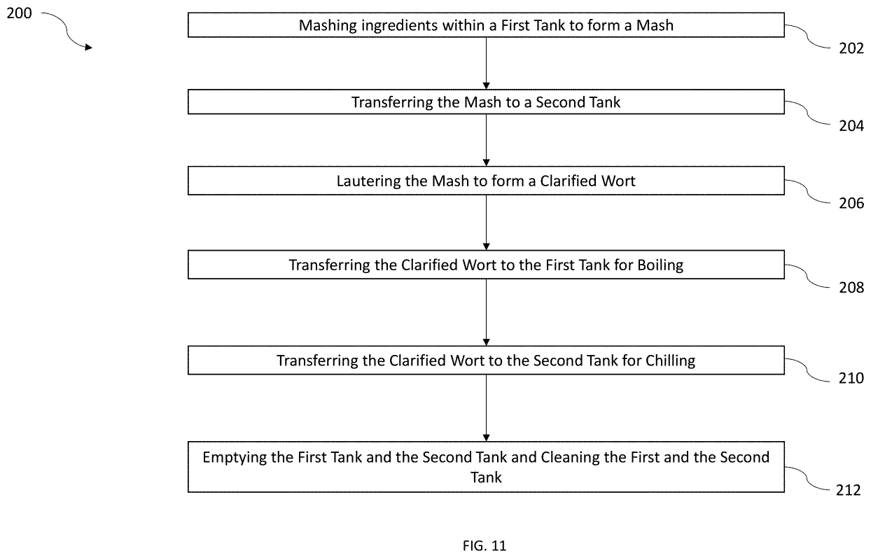

Additionally, as previously described, the brewing system 10 includes the air compressor 36 and an air tank 37 arranged between the first tank 14 and the second tank 16. The air compressor 36 is illustrated in FIG. 9 and is configured for working with the air tank 37 and an air bag (not shown) to define an airlifter system. The air lifter system allows for the height H1 of the brewing system 10 to be increased or decreased. This may be particularly useful for raising the brewing system 10 to clean underneath the brewing system 10, for transporting the brewing system 10 and for optimizing the design of the brewing system 10.

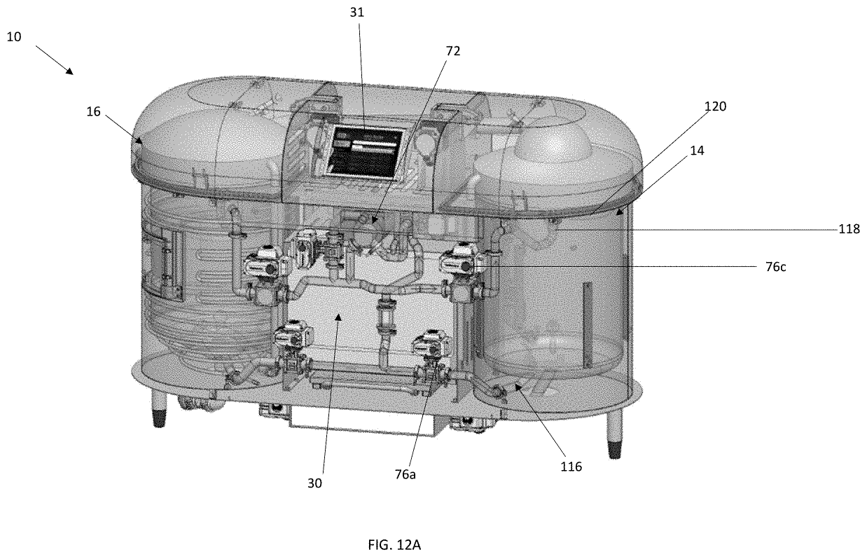

With reference now to FIG. 10, the reservoir 34 will be described further. As illustrated, the reservoir 34 is generally rectangular in shape and includes an outlet 110 on a top surface of the reservoir 34. The outlet 110 may be configured for coupling with the various pipes 74 of the piping group 70 to allow for fluid to enter and/or exit the reservoir 34 during the brewing process and the cleaning process that occurs in the brewing system 10. The reservoir 34 may additionally include an end cap 114 which may reversibly cover the outlet 110.

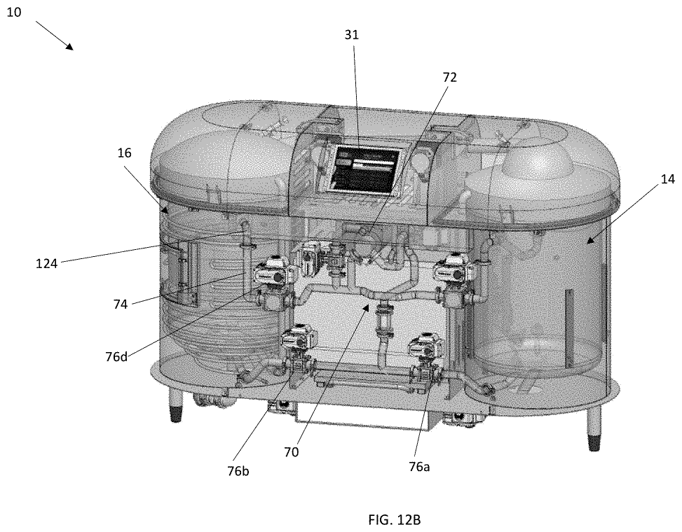

With reference now to the flow chart of FIG. 11 and the schematic views of FIGS. 12A-12H, the fluid flow through the brewing system 10 during at least a portion of the brewing process will be described further herein. FIG. 11 is a flow chart of a method 200 of operating a piping system during the process of brewing a fluid, such as a beer. As illustrated, the method 200 includes a first step at block 202 of mashing ingredients within the first tank 14. The ingredients within the first tank 14 may be chosen based on the recipe that is selected from the operator interface 31. In some examples, the ingredients include grains and water. FIG. 12A illustrates the brewing system 10 with the outer housing 12 shown in a translucent shade to show the internal components of the brewing system 10 with arrows indicating the fluid flow through the piping group 70 during the step shown at block 202 of the method 200.

More specifically, FIGS. 12A-12H illustrate the brewing system 10 with the outer housing 12 shown in a translucent shade illustrating the internal components of the brewing system 10 with arrows noted throughout which may illustrate the fluid flow direction through the piping group 70 and various other components of the brewing system 10, during the step of mashing the ingredients. More specifically, as indicated by the arrows in FIG. 12A, the ingredients retained within the first tank 14 exit the first tank 14 through an outlet pipe 116 of the first tank 14, through the first actuator 76a, through pipes 74 of the piping group 70, and then through the reservoir 34. The fluid may then be transferred through the impeller pump 72, through the third actuator 76c, into an inlet pipe 118 of the first tank 14 and thus a rotary arm 120 of the first tank 14 and back into the interior region of the first tank 14. In this way, the ingredients are repeatedly circulated through the first tank 14. This may be completed several times to define the mashing step of the brewing process.

With reference again to the method 200 shown in FIG. 11, the method 200 then includes a step at block 204 including transferring the mash to the second tank 16. For example, FIG. 12B illustrates a perspective view of the brewing system 10 with the outer housing 12 shown in translucency during this step of the brewing process. As indicated by the arrows in FIG. 12B, during this step, the mash formed within the first tank 14 is transferred through the outlet pipe 116 of the first tank 14, into pipes 74 of the piping group 70 and into an inlet pipe 124 of the second tank 16 for further processing.

With reference again to FIG. 11, the method 200 then includes the step at block 206 which includes lautering the mash to form a clarified wort. For example, this step is schematically illustrated in FIG. 12C showing the mash that was transferred into the second tank 16 being removed from the second tank 16 and repeatedly sent back into the second tank 16. More particularly, the fluid within the second tank 16, (e.g., the mash) exits through an outlet pipe 126 of the second tank 16, is delivered through various pipes 74 of the piping group 70 and is received into the reservoir 34. The mash is then delivered into the inlet pipe 124 and a whirl arm 128 of the second tank 16 to reenter the second tank 16 and undergo circulation due to rotation of the whirl arm 128. The fluids are repeatedly removed from the second tank 16 and reentered into the second tank 16 to define the lauter process. Due to the presence of the grid basket assembly 66, circulation of the mash through the second tank 16 causes sugars to be filtered and caught through the grid basket assembly 66 while the clarified mash, also referred to as wort, can pass through the grid basket 67. This circulation continues until the wort is clarified to a predetermined desired clarity. The clarification level of the wort may be measured by various different types of mechanisms. For example, the operator may monitor the clarification of the wort through the sight glass 86, or through a camera, flow sensor, or turbidity sensor that may be incorporated into the piping group 70; however, in further embodiments, various other mechanisms for measuring the clarity of the wort may be incorporated. Once the wort is determined to be sufficiently clear, water is cycled into the second tank 16 though the components of the piping group 70.

With reference again to FIG. 11, the method 200 further includes the step at block 208 which includes transferring the clarified wort to the first tank 14, where the clarified wort and the water may then be boiled. In embodiments, this step includes transferring the water and the wort out of the outlet pipe 126 of the second tank 16, through the various pipes 74 and actuators 76 of the piping group 70 and into the inlet pipe 118 of the first tank 14. Further, in some embodiments this step further includes cleaning the second tank 16 while the wort and the water is being boiled within the first tank 14. More particularly, at least two spray balls 130a, 130b and the whirl arm 128 of the second tank 16 work to circulate water through the second tank 16 to clean out the remnants of the wort. Once the cleaning is completed, the water used for cleaning the second tank 16 exits through a waste-water tank outlet pipe 132 of the second tank 16 and into the waste-water tank 38.

In some embodiments, the method 200 may additionally include the step of the chiller 32 and the piping group 70 pre-cooling the second tank 16 in order to cool the wort. More particularly, water is cooled through the chiller 32 to a temperature of approximately 7 degrees Celsius and is delivered through coils that may be arranged between the inner cylinder 46 and the outer cylinder 48 of the second tank 16. Once the second tank 16 is chilled to a determined temperature, which may depend on the recipe that is chosen through the operator interface 31, the method 200 further includes the step illustrated at block 210 in FIG. 11 which includes the boiled wort being transferred back into the second tank 16. This step is facilitated by the actuators 76 of the piping group 70 and the impeller pump 72 of the piping group 70. The addition of the boiled wort is conducted through the exit point of the second tank 16 to reduce the amount of oxygen and carbon dioxide build up within the second tank 16. The boiled wort remains in the second tank 16 as it is cooled until reaching a point of requiring fermentation. At this point, fermentation may either be conducted within the second tank 16 or the cooled wort may be transferred to a separate tank for fermentation to be conducted. In the embodiments wherein the fermentation is conducted within the second tank 16, the brewing process may be completed after the fermentation step and the beer may be removed from the second tank 16. For example, FIG. 12D illustrates the beer exiting through the outlet pipe 126 of the second tank 16 and out of the brewing system 10.

In the embodiments wherein the fermentation may be conducted within another tank, the method 200 further includes the step at block 212 (FIG. 11) including emptying the first tank 14 and the second tank 16 and cleaning the first tank 14 and the second tank 16. More specifically, the piping group 70 may work to drain the chilled wort from the second tank 16 in accordance with the schematic illustration of FIG. 12D. Further, any remaining fluids within the first and second tanks 14, 16 may be drained from the first tank 14 and the second tank 16 through the waste-water tank outlet pipe 132 of the second tank 16 and a waste-water tank outlet pipe 134 of the first tank 14. This is illustrated in FIG. 12E as indicated by the arrows illustrating the fluid flowing out of the first and second tanks 14, 16 and into the waste-water tank 38.

Further, in embodiments, cleaning of the first and the second tank 14, 16 is facilitated by an automated self-cleaning process that is conducted by the piping group 70. More particularly, cleaning agents may be added into the first tank 14 by the operator. As illustrated in FIGS. 12F-12H, water is then transferred from an outside water connection into the first tank 14 through pipes 74 of the piping group 70 to mix with the cleaning agents. The components of the piping group 70 and various inlet and outlet pipes of the first tank 14 and the second tank 16 allow the mixture of the cleaning agents and the water to enter the first tank 14, circulate through the first tank 14, push the cleaning mixture into the second tank 16, and circulate within the second tank 16. The impeller pump 72 may operator at a higher revolution per minute (rpm) to cause aggressive flow of the cleaning mixture through the brewing system 10. Further, the self-cleaning process then includes wherein the cleaning mixture is transferred out of the second tank 16 through the waste-water tank outlet pipe 134 of the second tank 16 and into the waste-water tank 38 for later disposal by the operator.

In some embodiments, an additional cycle of cleaning may be incorporated with includes water entering into the first tank 14 from the outside water connection and through pipes 74 of the piping group 70. The water is boiled within the first tank 14 and then is circulated through the first tank 14 and into the second tank 16 to clean the first tank 14 and the second tank 16 once more. The water may then be delivered into the waste-water tank 38 through the waste-water tank outlet pipes 134, 132 of the first tank 14 and the second tank 16. In further embodiments, additional circulations of water and/or cleaning agents may be incorporated to properly clean the first tank 14 and the second tank 16.

The above described fluid coupling system 30 allows for the brewing system 10 to automatically brew a beverage, for example beer, in the first tank 14 and the second tank 16 of the brewing system 10. The fluid coupling system 30 further facilitates a self-cleaning process of the brewing system 10. This is particularly beneficial in that it provides an automatic and efficient method of cleaning the brewing system 10 before, after or in between brewing processes.

The following clauses are provided as example aspects of the disclosed subject matter:

1. A fluid coupling system of a brewing system arranged laterally between a first tank and a second tank of the brewing system, the fluid coupling system comprising: a plurality of pipes coupled with one another and configured to couple with the inlet and outlet of the first tank and the inlet and the outlet of the second tank; at least one impeller pump coupling with at least one pipe of the plurality of pipes; and at least one actuator coupled with at least one pipe of the plurality of pipes configured to aid in facilitating fluid flow through the fluid coupling system; wherein the fluid coupling system is configured to facilitate fluid flow through the first tank and the second tank during a brewing process.

2. The fluid coupling system of clause 1, wherein the fluid coupling system is configured to facilitate cleaning of the brewing system.

3. The fluid coupling system of clause 2, wherein the fluid coupling system automatically facilitate the cleaning of the brewing system.

4. The fluid coupling system of clause 1, wherein the first tank includes a rotatory arm disposed therein and the second tank includes a whirl arm disposed therein.

5. The fluid coupling system of clause 4, wherein the impeller pump is a bidirectional pump and is configured to control a speed of rotation of the rotary arm and the whirl arm.

6. The fluid coupling system of clause 5, wherein the impeller pump is configured to facilitate fluid passage through the first tank and through the second tank.

7. The fluid coupling system of clause 1, wherein the at least one actuator includes a first actuator, a second actuator and a third actuator, and wherein the positioning of the first, second and third actuators may be altered in order to facilitate fluid flow through the fluid coupling system, the first tank and the second tank.

8. A method of brewing a beverage using a brewing system, wherein the brewing system includes a fluid coupling system having at least a plurality of pipes, the fluid coupling system arranged laterally between a first tank and a second tank, the method comprising: mashing ingredients within the first tank to form a mash; transferring the mash into the second tank; lautering the mash to form a clarified wort within the second tank; transferring the clarified wort to the first tank for boiling; transferring the clarified wort to the second tank for chilling; emptying the first tank and the second tank; and cleaning the first tank and the second tank.

9. The method of clause 8, wherein the step of mashing ingredients within the first tank to form a mash includes circulating the ingredients out of and back into the first tank and through a rotatory arm of the first tank.

10. The method of clause 9, wherein a rotation speed of the rotary arm is controlled by an impeller pump of the fluid coupling system.

11. The method of clause 8, wherein the step of lautering the mash to form a clarified wort within the second tank includes circulating the mash out of and back into the second tank and through a whirl arm of the second tank.

12. The method of clause 11, wherein a rotation speed of the whirl arm is controlled by an impeller pump of the fluid coupling system.

13. The method of clause 8, wherein the fluid coupling system includes a plurality of pipes, at least one actuator and at least one impeller pump to define a piping group.

14. The method of clause 8, wherein the fluid coupling system includes a reservoir, a chiller, and a waste-water tank.

15. The method of clause 8, where at least the cleaning of the first tank and the second tank is conducted automatically.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided the description and illustration of the present application, one skilled in art may envision variations, modifications, and alternate aspects falling within the spirit of the broader aspects of the general inventive concept embodied in this application that do not depart from the broader scope of the claimed disclosure.

1. A fluid coupling system of a brewing system arranged laterally between a first tank and a second tank of the brewing system, the fluid coupling system comprising:
a plurality of pipes coupled with one another and configured to couple with the inlet and outlet of the first tank and the inlet and the outlet of the second tank;
at least one impeller pump coupling with at least one pipe of the plurality of pipes; and
at least one actuator coupled with at least one pipe of the plurality of pipes configured to aid in facilitating fluid flow through the fluid coupling system;
wherein the fluid coupling system is configured to facilitate fluid flow through the first tank and the second tank during a brewing process.

2. The fluid coupling system of claim 1, wherein the fluid coupling system is configured to facilitate cleaning of the brewing system.

3. The fluid coupling system of claim 2, wherein the fluid coupling system automatically facilitate the cleaning of the brewing system.

4. The fluid coupling system of claim 1, wherein the first tank includes a rotatory arm disposed therein and the second tank includes a whirl arm disposed therein.

5. The fluid coupling system of claim 4, wherein the impeller pump is a bidirectional pump and is configured to control a speed of rotation of the rotary arm and the whirl arm.

6. The fluid coupling system of claim 5, wherein the impeller pump is configured to facilitate fluid passage through the first tank and through the second tank.

7. The fluid coupling system of claim 1, wherein the at least one actuator includes a first actuator, a second actuator and a third actuator, and wherein the positioning of the first, second and third actuators may be altered in order to facilitate fluid flow through the fluid coupling system, the first tank and the second tank.

8. A method of brewing a beverage using a brewing system, wherein the brewing system includes a fluid coupling system having at least a plurality of pipes, the fluid coupling system arranged laterally between a first tank and a second tank, the method comprising:
mashing ingredients within the first tank to form a mash;
transferring the mash into the second tank;
lautering the mash to form a clarified wort within the second tank;
transferring the clarified wort to the first tank for boiling;
transferring the clarified wort to the second tank for chilling;
emptying the first tank and the second tank; and
cleaning the first tank and the second tank.

9. The method of claim 8, wherein the step of mashing ingredients within the first tank to form a mash includes circulating the ingredients out of and back into the first tank and through a rotatory arm of the first tank.

10. The method of claim 9, wherein a rotation speed of the rotary arm is controlled by an impeller pump of the fluid coupling system.

11. The method of claim 8, wherein the step of lautering the mash to form a clarified wort within the second tank includes circulating the mash out of and back into the second tank and through a whirl arm of the second tank.

12. The method of claim 11, wherein a rotation speed of the whirl arm is controlled by an impeller pump of the fluid coupling system.

13. The method of claim 8, wherein the fluid coupling system includes a plurality of pipes, at least one actuator and at least one impeller pump to define a piping group.

14. The method of claim 8, wherein the fluid coupling system includes a reservoir, a chiller, and a waste-water tank.

15. The method of claim 8, where at least the cleaning of the first tank and the second tank is conducted automatically.
